(19) United States
(12) Patent Application Publication
(10) Pub. No.: US 2023/0366993 A1
(43) Pub. Date: Nov. 16, 2023

(54) SYSTEMS AND METHODS FOR LIDAR SIGNAL PROCESSING

(71) Applicant: Shanghai Lingfang Technology Co., Ltd., Shanghai (CN)

(72) Inventors: Tairan SUN, Shanghai (CN); Yunfei Ma, Shanghai (CN); Letian Wang, Shanghai (CN)

(21) Appl. No.: 18/315,297

(22) Filed: May 10, 2023

(30) Foreign Application Priority Data
May 10, 2022 (CN) 202210505426.7

(51) Int. Cl. G01S 7/4865; G01S 7/487; G01S 17/10

(52) U.S. Cl. CPC G01S 7/4866; G01S 7/4873; G01S 17/10

(57) ABSTRACT

The present invention is directed to LiDAR systems and methods. In specific embodiments, the received signal is transformed into a histogram, facilitating the identification and filtering of one or more peaks to enhance accuracy. Various other embodiments are also provided, offering diverse solutions for optimizing LiDAR performance in different applications.

### CROSS-REFERENCES TO RELATED APPLICATIONS

The present application claims priority to U.S. Provisional Application No. 202210505426.7, filed 10 May 2023, which is common own and incorporated by reference herein for all purposes.

### BACKGROUND OF THE INVENTION

Light Detection and Ranging (LiDAR) technology plays a crucial role in various applications, such as autonomous vehicles, robotics, and surveying. It uses laser light to measure distances and create accurate 3D representations of the environment. However, the performance of existing LiDAR systems can be negatively affected by interference signals caused by glare, dust, and reflections, which introduce additional small peaks in the histogram, resulting in distance detection errors.

Over the past, various approaches have been proposed, but they are inadequate. New and improved systems and methods are desired.

### BRIEF SUMMARY OF THE INVENTION

The present invention is directed to LiDAR systems and methods. In specific embodiments, the received signal is transformed into a histogram, facilitating the identification and filtering of one or more peaks to enhance accuracy. Various other embodiments are also provided, offering diverse solutions for optimizing LiDAR performance in different applications.

According to an embodiment, the present invention provides a LiDAR system configured to determine target object distance by processing reflected laser signals. The system comprises a laser source, an optical module, a pixel circuit, a time-to-digital converter (TDC), a memory device, and a processor module. The laser source generates a pulsed laser, and the optical module receives the reflected laser signal. The pixel circuit generates an electrical output based on the reflected signal, which the TDC uses to generate histogram data.

The processor module identifies and selects peaks from the histogram data, calculates a preliminary peak location associated with the target object distance, and compares it to a threshold value. The processor module then calculates the time of flight (TOF) value and determines the target object distance. Various embodiments of the system include configurations for removing additional peaks, handling non-linear responses, using SPAD sensors, and comparing peak values to different threshold values for various scenarios such as high reflection, glare, glass reflection, and dust particles. The processor module may also identify additional peaks and determine location differences in some embodiments.

According to another embodiment, the present invention provides a LiDAR system configured to determine target object distance by processing reflected laser signals. The system comprises a laser source, an optical module, a pixel circuit, a time-to-digital converter (TDC), a memory device, and a processor module. The laser source generates a pulsed laser, and the optical module receives the reflected laser signal. The pixel circuit generates an electrical output based on the reflected signal, which the TDC uses to generate histogram data.

The processor module identifies a plurality of peaks, selects a first peak associated with a preliminary peak location, and associates an artifact type to at least a second peak characterized by a low magnitude or variance. The processor module calculates the preliminary peak location, compares it to a threshold value, and calculates the time of flight (TOF) value to determine the target object distance. Various embodiments of the system include configurations for handling low magnitude peaks, glare characteristics, dust particle locations, and glass reflections. The processor module may also evaluate matching functions using the identified peaks or pulse widths in some embodiments.

According to another embodiment, the present invention provides a LiDAR system designed to determine target object distance by processing reflected laser signals. This system includes a laser source, an optical module, a pixel circuit, a time-to-digital converter (TDC), a memory device, and a processor module. The laser source generates a pulsed laser, and the optical module receives the reflected laser signal. The pixel circuit generates an electrical output based on the reflected signal, which is then used by the TDC to create histogram data.

The processor module identifies multiple peaks and selects at least a first peak associated with a preliminary peak location and characterized by a second pulse width. It also associates an artifact type to at least a second and third peak from the plurality of peaks, with the second peak being characterized by a variance. Using the histogram data, the processor module calculates the preliminary peak location and compares it to a threshold value to determine the target object distance by calculating the time of flight (TOF) value.

In various embodiments, the variance is associated with dust particle locations or glass reflections. Additionally, the processor module may evaluate a matching function using at least the first and second peaks or using the second pulse width.

It is to be appreciated that embodiments of the present invention provide many advantages over conventional techniques. Among other things, embodiments of the present invention provide techniques for enhancing peak detection for accurate and reliable distance measurements and effectively filters and selects candidate peaks using preset matching functions and feature vectors. The adaptability of the algorithm allows for easy adjustments to various parameters and thresholds, making it suitable for diverse applications.

Embodiments of the present invention can be implemented in conjunction with existing systems and processes. For example, techniques according to the present invention can be used in a wide variety of systems, including different types of lidar systems. Additionally, various techniques according to the present invention can be adopted into existing systems via firmware or software installation. There are other benefits as well.

The present invention achieves these benefits and others in the context of known technology. However, a further understanding of the nature and advantages of the present invention may be realized by reference to the latter portions of the specification and attached drawings.

### BRIEF DESCRIPTION OF THE DRAWINGS

FIG. 1 is a simplified diagram illustrating operation of LiDAR sensor that is configured to measure its distance to a target.

FIG. 2 is a simplified flow diagram illustrating a method of processing and enhancing data received by a LiDAR sensor according to embodiments of the present invention.

FIGS. 3 and 4 are graphs illustrating histogram being used to enhance data received by a LiDAR sensor according to embodiments of the present invention.

FIG. 5 is a simplified block diagram illustrating a LiDAR system according to embodiments of the present invention.

### DETAILED DESCRIPTION OF THE INVENTION

The present invention is directed to LiDAR systems and methods. In specific embodiments, the received signal is transformed into a histogram, facilitating the identification and filtering of one or more peaks to enhance accuracy. Various other embodiments are also provided, offering diverse solutions for optimizing LiDAR performance in different applications.

As mentioned above, existing methods for operating LiDAR have been inadequate. More specifically, existing techniques employed to address these issues, such as median filtering, Gaussian filters, pre-set distance detection, signal-to-noise ratio calculations, and peak position-based selection, are unable to effectively remove interference peaks, ultimately limiting the LiDAR's performance. Therefore, there is a need for a method that improves the LiDAR performance by effectively eliminating interference signals, ensuring the accurate measurement of distances, and maintaining the integrity of the high-frequency depth information.

For example, in the process of array ranging and imaging, it is often needed to perform signal processing on the image data, and then obtain the distance information to be measured based on the processing results. In image data, there are often interference signals caused by glare, dust, module and cover plate reflection, which can cause some pixels to introduce additional small peaks beyond the target object into the histogram during the ranging process, resulting in distance detection errors. If there is only one target object during ranging, there should be only one peak in the histogram. The maximum value of this peak corresponds to the time bin and the distance from the target object to the detector, but if multiple peaks appear in the histogram, it may be misread and the small peaks formed by interference may be used as the target peak, resulting in distance detection errors.

Some existing approaches for processing LiDAR data primarily focus on noise removal in histograms through techniques like median filtering and Gaussian filtering. However, these methods are not effective in eliminating glare from large areas, and they may result in the loss of valuable depth information at high frequencies. Another technique involves selecting the nearest or farthest peak based on pre-set detection limits for the farthest and closest distances. However, this method requires an initial estimation of the target object's approximate distance, which introduces additional constraints and limitations to the measurement process.

Another approach to processing LiDAR data involves calculating the signal-to-noise ratio (SNR) for each peak, discarding peaks with a low SNR and retaining peaks with a high SNR. However, this method is not effective in eliminating interference caused by glare from nearby dust particles or highly reflective objects, and it fails to optimize the removal of smaller peaks. In certain cases, the selection of distant peak outputs is based on peak position, but when multiple target objects are present, both nearby and distant peaks are considered effective peaks. As a result, this method cannot be solely relied upon for effective filtering and accurate target object identification.

Embodiments of the present invention aim to enhance the signal processing capabilities of LiDAR systems, resulting in more accurate detection of target objects and improved elimination of interference peaks. By implementing these advancements, the overall performance and reliability of LiDAR systems can be significantly improved, offering a higher degree of precision in various applications.

The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the Claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

An embodiment of this application provide an image processing method to effectively remove invalid peaks from all peaks, thereby enhancing the performance of LiDAR systems in obtaining distance information of target objects.

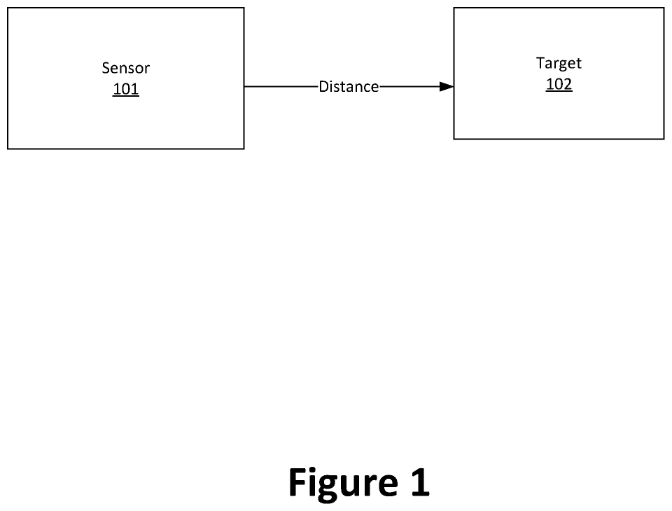

In research and practical applications, obtaining distance information of target objects may be important. As shown in FIG. 1, during the array ranging and imaging process, image data obtained from sensor 101 is processed to acquire the distance information of target object 102, fulfilling research and application requirements.

The construction of a matching function and utilization of feature vectors are based on the following principle:

Laser receiving power:

Pᵣₓ=Pₜₓ*(σ/(α*β*R²))*η_{reflct}*(Arec/(pi*R²))*ηₐₜₘ²*η_{Rx} Formula (*)

Here, Pᵣₓ represents received power; Pₜₓ denotes transmission power; σ refers to the target receiving area; R is the distance from the target object to the SPAD sensor; α*β is the FOI emission angle; α*β*R² signifies the light receiving area corresponding to the ROI solid angle; η_{reflct} represents the reflectivity of the target object; Arec is the photon collection efficiency (typically the lens area); ηₐₜₘ refers to atmospheric propagation efficiency, and η_{Rx} denotes the photoelectric conversion efficiency of the SPAD sensor.

As implemented in various scenarios, it can be seen that, except for η_{reflct} and R, other factors affecting return energy are mainly related to the device module, implying that the same module's parameters are essentially constant. Therefore, the received power Pᵣₓ is primarily related to η_{reflct} and R.

Pᵣₓ∞η_{reflct}/R²˜η_{reflct}/R⁴

Considering the target light receiving area a greater than the corresponding light collecting area of the ROI solid angle (α*β*R²), Pᵣₓ can be considered to be proportional to η_{reflct}/R². The peak number of photons in the histogram (peak_count) can be simply expressed as:

peak_count ∝Pᵣₓ∝η_{reflct}/R²

Using peak_count and R (Ti*c/2), the target object's reflectivity η_{reflct} can be calculated. Subsequently, the scale coefficient k*η_{reflct} can be determined, where k remains constant for the same measurement, facilitating the sorting of reflectance η_{reflct}.

The principle of reflectivity compensation takes into account the nonlinearity of the SPAD sensor. When the target object has high reflectivity, the received pulse narrows, the rising edge decreases, and the falling edge widens due to the SPAD jitter effect. These three characteristics allow for the construction of a waveform matching function to further compensate for the reflectivity scale coefficient.

When the received pulse energy is particularly high (greater than the first threshold), the estimation of the reflectivity coefficient is increased, as it can be confirmed as a high reflectivity target object. If the received pulse energy is average (less than the first threshold but greater than the second threshold), the estimation of the reflectivity coefficient remains uncompensated. When the received pulse energy is low (less than the second threshold), the pulse width is used for matching.

In operating LiDAR systems, it is helpful to eliminate the following artifacts for optimal performance:

1. Environmental noise elimination. Considering the noise characteristics, the received pulse width does not match the emitted reference pulse width. The more consistent the received pulse width and the emitted reference pulse width, the more likely it is to be an effective echo. The power of the effective signal, P_{signal}, is related to the pulse width τ: P_{signal}=1/exp (abs(τi−τk)/τk).

2. Glare elimination. Glare results from light reflections within the lens, and the equivalent reflectivity of glare points is generally between 0.01% and 1% of the glare source point reflectivity (depending on the lens used). Consequently, the reflectivity of glare points is much lower than that of normal objects, making low reflectivity target points more likely to be glare (92% correlation for flat scenes, 96% correlation for general scenes, and 83% correlation for special scenes). By constructing a distance normalization function to obtain the target reflectance scale coefficient, target points less prone to glare can be identified.

3. Glass identification. The reflectivity of glass varies significantly. If the reflectivity scale coefficient across multiple frames is generally small and there are image points, it can be determined that the point is likely a glass point.

4. Dust identification. Dust has high reflectivity, but its reflectivity significantly differs from surrounding objects. Moreover, there is positional uncertainty between multiple frames, which can be used to differentiate dust from other elements in the scene.

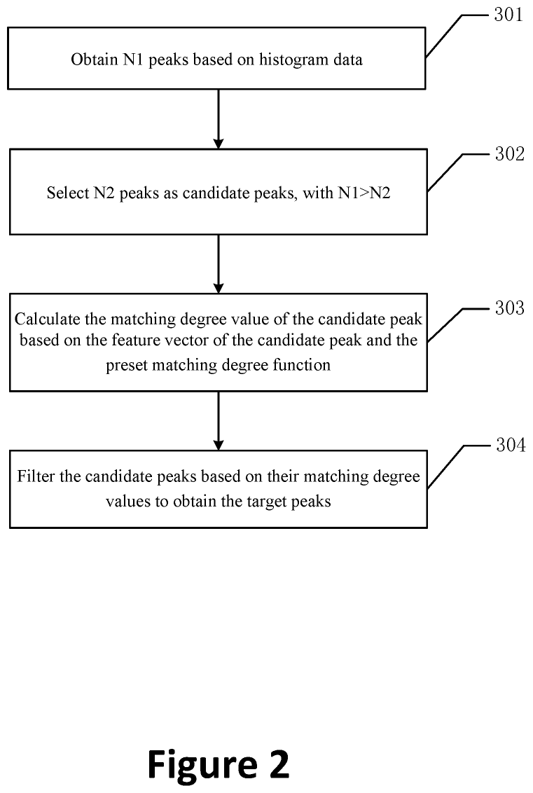

The following describes an embodiment of an image processing method based on the information provided above, with reference to FIG. 2. An embodiment of the image processing method includes the steps below.

Step 301: Obtain N1 peaks based on histogram data. After acquiring the histogram data, N1 peaks related to the histogram data are identified as a prerequisite for filtering.

Step 302: Select N2 peaks as candidate peaks, with N1>N2. The N2 peaks are selected as candidate peaks, specifically including:
Set peak threshold and peak characteristic conditions.
Selecting the N1 peaks and determine the N2 peaks that exceed the threshold and meet the peak characteristic conditions as candidate peaks.

Preferably, after selecting N2 peaks as candidate peaks, the method also includes constructing a feature vector of the candidate peak and developing a corresponding matching function based on the feature vector. The feature vector comprises: the time bin corresponding to the peak, the photon count value corresponding to the peak, pulse width, rising edge time, and falling edge time.

Step 303: Calculate the matching degree value of the candidate peak based on the feature vector of the candidate peak and the preset matching degree function. The feature vector is a vector related to the shape and size of the peak.

Specifically, interference can be glare. The reflectivity of glare points is much lower than that of normal objects. Interference can also be dust. Dust particles are small but have high reflectivity, and their corresponding peak stability is poor. Interference can also be caused by glass, which has a significant change in reflectivity, or there may be other interference factors, which are not limited here.

1. When the feature vector includes the time bin corresponding to the peak and the photon count value corresponding to the peak, the matching degree function is:

Mᵢ=k×Ci×(Ti−n)² Formula 1:

Where the matching degree value of the i-th peak among the candidate peaks (i=1, 2, 3 . . . ); the photon count value corresponding to the i-th peak among the candidate peaks; the time bin corresponding to the i-th peak among the candidate peaks; the correction parameters k and n, and the speed of light c.

2. When the feature vector includes the time bin corresponding to the peak, the photon count value corresponding to the peak, and the pulse width, the matching degree function is:

$$Mi = \frac{k}{{e}^{abs ( τ i - τ k ) / τ k}} \times Ci \times {( Ti - n )}^{2} \qquad Formula 2$$

Where τi is the pulse width of the i-th peak among the candidate peaks, and τk is a value related to the emission waveform.

3. When the feature vector includes the time bin corresponding to the peak, the photon count value corresponding to the peak, rising edge time, and falling edge time, the matching function is:

$$Mi = k \times \frac{τ i \_ dn}{τ i \_ up} \times Ci \times {( Ti - n )}^{2} \qquad Formula 3$$

Where τi_up is the rising edge time and τi_dn is the falling edge time.

4. When the feature vector includes the time bin corresponding to the peak, the photon count value corresponding to the peak, pulse width, rising edge time, and falling edge time, the matching function is:

$$Mi = k ( τ i ) \times \frac{τ i \_ dn}{τ i \_ up} \times Ci \times {( Ti - n )}^{2} \qquad Formula 4$$

Where k(τi) is a parameter related to the pulse width.

k(τi) can be determined as follows:

If Ci×(Ti−n)² is greater than the first threshold, k(τi)=k1*τk/τi, where τk is a value related to the emission waveform;

If Ci×(Ti−n)² is greater than the second threshold and less than the first threshold, k(τi)=k2;

If Ci×(Ti−n)² is less than the second threshold, k(τi)=k3/e\hat{ }(abs(τi−τk)/τk), where τk is a value related to the emission waveform; and

The first threshold is much greater than the second threshold.

In summary, the construction of matching degree functions is related to the problem that needs to be solved. Different matching degree functions can be constructed based on the demand scenario, or the same matching degree function can be constructed for multiple scenarios simultaneously. In practical engineering, it is necessary to calibrate the parameters of the required matching function based on experiments.

Step 304. Filter the candidate peaks based on their matching degree values to obtain the target peaks. Filtering the matching degree values of the obtained candidate peaks according to predefined filtering conditions. If a matching degree value meets the filtering conditions, the corresponding peak is identified as the target peak.

Specifically, target peaks can be determined by sorting the matching degree values. Sort the calculated matching degree values of the candidate peaks, and then identify the peaks with higher matching degree values as target peaks based on the sorted results. The number of target peaks can be one, two or more, and less than the number of candidate peaks. The specific number of target peaks can be determined according to the purpose.

In a specific embodiment, target peaks can also be determined using a preset threshold method. First, set a specific threshold according to the purpose, and then compare the calculated matching degree values of the candidate peaks with the preset threshold. If the matching degree value of a peak among the candidate peaks is greater than the preset threshold, identify that peak as a target peak. The number of target peaks can be one or more, depending on the purpose.

It is to be understood that filtering can be done through sorting or setting preset thresholds, among other methods. Specific details are not limited here.

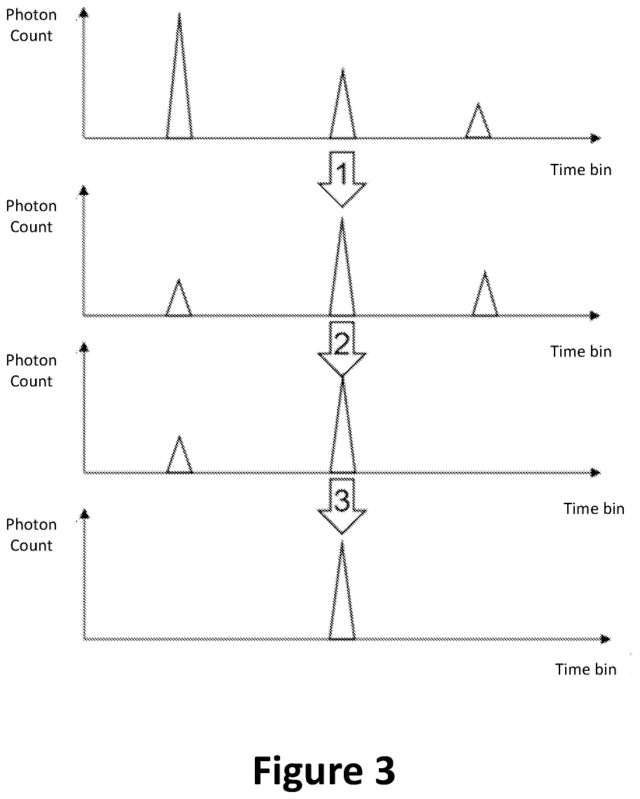

To facilitate understanding of the target peak filtering process, FIG. 3 provides a schematic diagram of the process of filtering target peaks from all peaks. Perform the first filtering on all peaks, and the peaks that meet the conditions are N1 peaks. Then filter the N1 peaks, which is the second filtering, to obtain N2 peaks. Identify N2 peaks as candidate peaks, and filter the candidate peaks using matching degree functions, photon count values, and time bins, which is the third filtering, to obtain the target peaks.

The following example illustrates how to apply the matching degree value to filter for effective peaks.

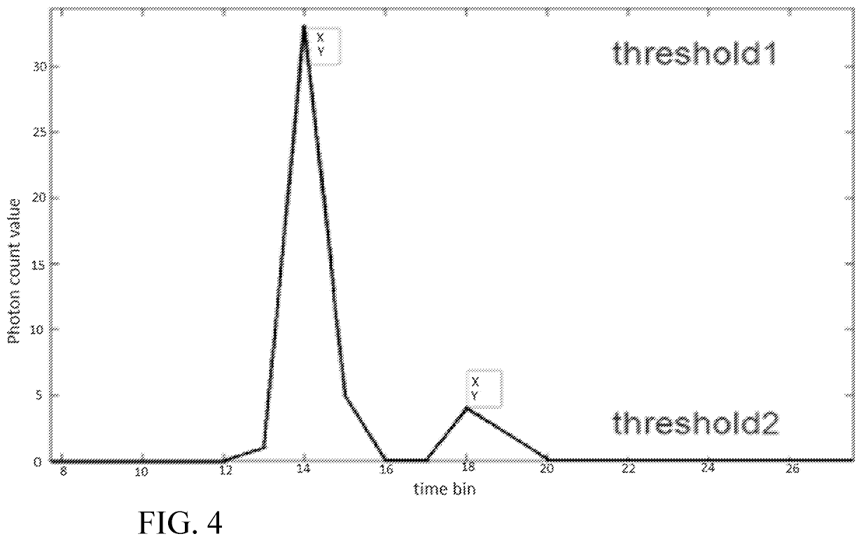

As shown in FIG. 4, there are two peaks in the histogram, and the eigenvectors of these two peaks are as follows:

| | Left peak | Right peak |
|---|---|---|
| Time bin corresponding to the peak: Ti | 14 | 18 |
| Photon count value corresponding to the peak: Ci | 33 | 4 |
| Pulse width: τi | 1.1049 | 1.5 |
| Rising edge time: τi_up | 0.5156 | 0.5 |
| Falling edge time: τi_dn | 0.5893 | 1 |

The left peak might be caused by glare. If conventional technology is used, i.e., selecting the highest peak as the effective peak of the target object, the glare-formed peak would be mistakenly used for distance calculation of the target object.

According to various embodiments, the present application can filter by calculating the matching degree value, as follows:

$$Mi = k ( τ i ) \times \frac{τ i \_ dn}{τ i \_ up} \times Ci \times {( Ti - n )}^{2}$$

Since the first threshold is 180, and the second threshold is 1,

The Ci of both peaks is greater than the second threshold and smaller than the first threshold; k(τi)=k2; it can be set k(τi)=1;

Then the matching degree value of the left peak:

M1=k(τi)×(τi_dn/τi_up)×Ci×(Ti−n)²=1×(0.5893/0.5156)×33×(14−11)²=339

The matching degree value of the right peak:

M2=k(τi)×(τi_dn/\hat{ }i_up)×Ci×(Ti−n)²=1×(1/0.5)×4×(18−11)²=392

Then, comparing M1 and M2, it is known that M2>M1. Since the matching degree value of the glare point is lower than that of normal objects, the left peak with a smaller M1 is caused by glare and can be removed. The right peak is the peak reflected by the target object and can be used to calculate the actual distance of the target object.

As an example,

If glare is detected, use formulas 1-4 to calculate, as follows:

M₁=k×Ci×(Ti−n)² 1. Formula 1 calculation:

M1=1*33*(14−11)²=297,

M2=1*4*(18−11)²=198

Because M1>M2, using formula 1 to calculate the matching degree values of the two peaks and then compare and sort, it is impossible to remove the left peak caused by glare.

2. Formula 2 calculation:

$$Mi = \frac{k}{{e}^{abs ( τ i - τ k ) / τ k}} \times Ci \times {( Ti - n )}^{2}$$

Mi=k/e\hat{ }(abs(τi−τk)/τk)×Ci×(Ti−n)²

M1=1/e(1.1049−1)*33*(14−11)²=0.9*297=267

M2=1/e(1.5−1)*4*(18−11)²=7.4*198=9.5, where τ_{K}=1

Because M1>M2, using Formula 1 to calculate the matching degree values of the two peaks and then compare and sort, it is impossible to remove the left peak caused by glare.

3. Formula 3 calculation:

$$Mi = k \times \frac{τ i \_ dn}{τ i \_ up} \times Ci \times {( Ti - n )}^{2}$$

M1=1*(0.5893/0.5156)*33*(14−11)²*33=1.14*297=338

M2=1*(1/0.5)*4*(18−11)²=2*198=392

Because M1<M2, using Formula 3 to calculate the matching degree values of the two peaks and then compare and sort, the left peak caused by glare can be removed.

4. Formula 4 calculation:

$$Mi = k ( τ i ) \times \frac{τ i \_ dn}{τ i \_ up} \times Ci \times {( Ti - n )}^{2}$$

It is necessary to determine whether Ci*(Ti−n)² is between the first threshold and the second threshold; the specific calculation process has been explained above, so it will not be repeated here.

Because M1<M2, using Formula 4 to calculate the matching degree values of the two peaks and then compare and sort, the left peak caused by glare can be removed.

Therefore, the construction of the specific matching degree function is related to the problem to be solved. If glare is to be eliminated, a matching degree function constructed using formula 3 or 4 should be used to calculate matching degree values. In actual engineering, the decision is mainly based on the measured histogram waveform because there are many influencing factors. It is impossible to use the same formula to calculate different noise sources in different scenarios. Therefore, different formulas need to be used for verification, and the formula may need to be modified, such as adding feature vectors to adjust the formula's relationship. The core is to calculate the reflectivity of the target object, find the noise through the reflectivity difference between the object and noise, and eliminate the noise, including environmental noise, glare, dust, glass, etc.

It is to be appreciated that embodiments of the present invention can provide various benefits:
1. Solve the elimination problem of non-target multiple peaks and the selection problem of small targets through peak characteristics and matching degree functions.
2. The sensor described in this application can identify glare areas. By subtracting the SPAD photosensitive area after elimination from the SPAD photosensitive area before elimination, the difference part is the glare area. Through this method, the results of the glare area can be sent to other sensors (RGB), enhancing the glare elimination capability of other sensors.
3. If the method of eliminating glare in this application is combined with spatial filtering, it can further eliminate the remaining 10% of glare points.

In various embodiments, peaks can be derived from histogram data, and signal peaks can be acquired through a single filtering process. The target peak can subsequently be obtained using a matching function. By employing a two-stage filtering approach, invalid peaks can be effectively removed, resulting in a higher elimination rate of invalid peaks compared to a single filtering method. This enhances the accuracy and reliability of the LiDAR system's peak detection process.

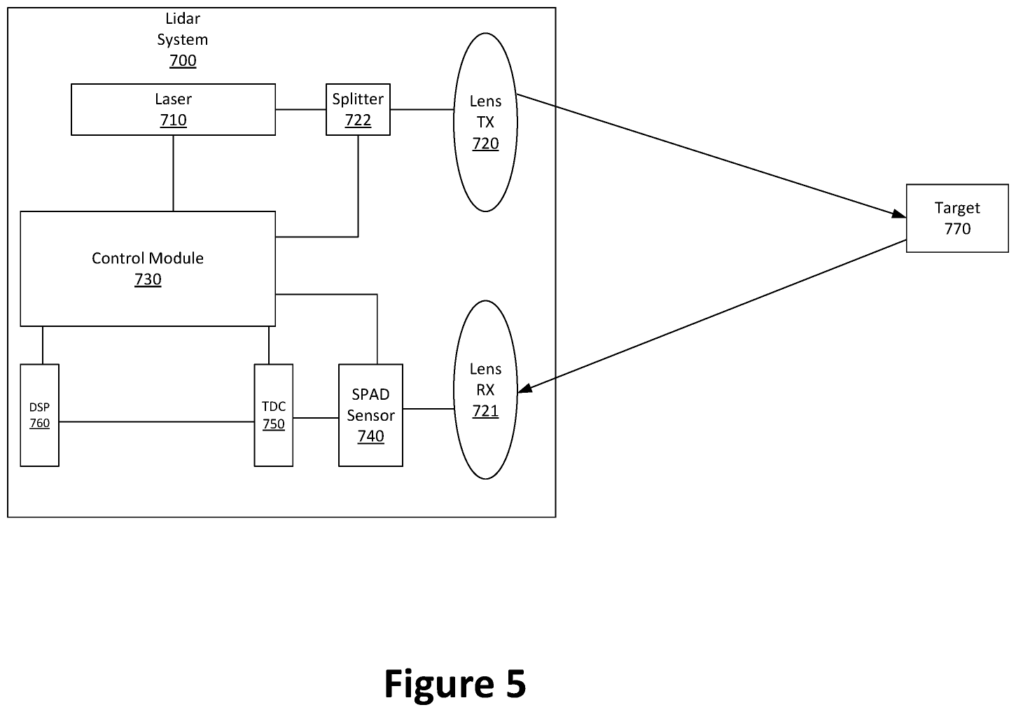

The following is a detailed description of the data processing device in the embodiments of this application. Please refer to FIG. 5, another embodiment of the data processing device 700 in this application.

FIG. 5 is a simplified block diagram illustrating lidar system 700 according to embodiments of the present invention. This diagram is merely an example, which should not unduly limit the scope of the claims. One of ordinary skill in the art would recognize many variations, alternatives, and modifications. In principle, lidar system 700 measures distance by calculating the time differences between transmitted light signals and the corresponding received signals. Laser 710, as controlled by the control module 730, emits laser pulses at predefined intervals. As example, laser 710 may include stacked laser diodes that emit diffracted laser beams. Depending on the application, the output of laser 710 may be pulsed infrared laser signals. The laser pulse profile (e.g., width, shape, intensity, etc.) and the predefined intervals depend largely on the lidar system implementation and specifications, such as power, distance, resolution, and others.

Lidar system 700 is configured to reconstruct images, with distance information, using a SPAD array that includes many SPAD pixels. For this application, the output of the laser 710 is manipulated to create a predefined pattern. It is understood that lens 720 refers to an optical module that may include multiple optical and/or mechanical elements. In certain implementations, lens 720 includes diffractive optical elements to create a desired output optical pattern. Lens 720 may include focusing and optical correction elements, configured in multiple lens elements.

Control module 730 manages operations and various aspects of lidar system 700. As shown, control module 730 is coupled to laser 710 and splitter 722, along with other components. Depending on the embodiment, control module 130 can be implemented using one or more microprocessors. For example, control module 730 may include a microprocessor that can be used for timing control of input and output and power control of laser 710. Components such as TDC 750 and digital signal processor (DSP) 760 as shown are functional blocks that are—on the chip layer—implemented with the same processor(s) for the control module 730. In addition to providing control signal signals to laser 710, control module 730 also receives the output of the laser 710 via splitter 722. Based on the output of splitter 722, control module 730 activates SPAD sensor 740, TDC 750, and other components to process received signals. Additionally, the output of splitter 722 provides the timing of the outgoing light signal, and this timing information is later used in ToF calculations.

Laser 710, in various embodiments, is configured to emit infrared light with a wavelength of 800 nm to 950 nm, where the data processing device of this application has good detection performance for peaks with a wavelength of 905 nm. It is understood that in other embodiments, the laser 710 can also emit infrared light with a wavelength of 1550 nm, which is not specifically limited here.

The transmitted laser signal, upon reaching target 770, is reflected. For example, the shape of and size of target 770 could affect the subsequent reflected laser signal, where the medium between the target object 770 and the lidar system 700 may include air and dust, which may also affect the reflected laser signal. The reflected laser signal is received by lens 721, which focuses the received laser signal onto SPAD sensor 740. Lens 721 may include multiple optical and mechanical elements. The transmission efficiency of lens 721 and reflection characteristics may affect the quality and quantity of light reception. For example, lens 721 may include an anti-reflective coating to address the glare problem caused by fully exposed or dispersed light source locations.

The SPAD sensor 740 converts the received laser signal into arrival signal pulses. In certain applications, a single SPAD pixel is sufficient for range determination, and a single TDC is implemented for that SPAD pixel. In various embodiments, the SPAD sensor 740 is implemented as a macro pixel, commonly referred to as a digital silicon photomultiplier (dSiPM). The TDC 750 consists of a number of TDCs (e.g., equal to the number of SPAD pixels) configured to process the arrival time of multiple pulses generated by the SPAD sensor 740. For instance, the TDCs in block 750 may be individually connected to their corresponding SPAD pixels in block 740 for efficient signal processing.

The output of TDC 750 is stored at a memory as a histogram data structure. For example, in a histogram data structure, memory blocks correspond to predefined time bins, and each of the memory blocks stores an intensity value (e.g., number of photons received within a predefined time interval). For example, the memory may include static random-access memory (SRAM), but other types of memory devices may be used as well.

In various implementations control module 730 is configured to perform sensor image processing method based on multi-peak detection, which includes:
finding N1 peaks based on histogram data;
filtering out N2 peaks as candidate peaks, where N1>N2; and
based on the feature vectors and preset matching functions of the candidate peaks, calculating the matching values of the candidate peaks.

For example, The feature vectors at least include the time bins corresponding to the peak values and the photon count values corresponding to the peak values. The preset matching function is a function related to the feature vectors, and the matching values of the candidate peaks reflect the reflectance of the actual object causing the candidate peaks. The target peak is obtained by filtering according to the matching values of the candidate peaks.

For example, system 700 is configured according to the following:

Laser reception power:

Pᵣₓ=Pᵣₓ*(σ/(α*β*R²))*η_{reflct}*(Arec/(pi*R 2))*ηₐₜₘ²*ηRx Formula (*):

Where, Pᵣₓ refers to reception power; Pᵣₓ refers to transmission power; σ is the target illuminated area, R is the distance from the target object to the SPAD sensor, α*β is the FOI emission angle, α*β*R\hat{ }2 is the illuminated area corresponding to the solid angle of ROI; η_{reflct} is the reflectance of the target object, Arec is the photon collection efficiency (generally the lens area), ηₐₜₘ is the atmospheric transmission efficiency, η_{Rx} is the photoelectric conversion efficiency of the SPAD sensor.

It can be seen that, except for η_{reflct} and R, other parameters affecting the return light energy are generally related to the device module, that is, the parameters are basically consistent for the same module, so the reception power Pᵣₓ is mainly associated with η_{reflct} and R.

It can be seen that the laser reception power Pᵣₓ is related to the parameters of hardware components.

It is to be understood that specific working processes of the systems, devices, and units described above can refer to the corresponding processes in the method embodiments mentioned earlier, and will not be discussed further here.

In various embodiments provided in this application, it should be understood that the disclosed systems, devices, and methods can be implemented in other ways. For example, the device embodiments described above are merely schematic. For instance, the division of various components may be a logical functional categorization, and there may be other ways of organizing them in actual implementation. For example, multiple units or components can be combined or integrated, or some features can be omitted or removed. Furthermore, the coupling or direct coupling or communication connections shown or discussed between them can be indirect coupling or communication connections through some interfaces, devices, or units, and can be electrical, mechanical, or other forms.

While the above is a full description of the specific embodiments, various modifications, alternative constructions and equivalents may be used. Therefore, the above description and illustrations should not be taken as limiting the scope of the present invention which is defined by the appended claims.

What is claimed is:

1. A lidar system comprising:
a laser source configured to generate a pulsed laser at a first time, the pulsed laser being characterized by a first pulse width;
an optical module configured receiving a reflected laser signal;
a pixel circuit configured to generate an electrical output based on the reflected laser signal;
a time-to-digital converter (TDC) configured to generate a histogram data using at least the electrical output, the histogram data comprising n intensity values corresponding to n time bins;
a memory device configured to store the histogram data; and
a processor module configured to:
identifying a first peak and a second peak using the histogram data;
selecting between at least the first peak and the second peak to designate a preliminary peak location, the first peak being characterized by a second pulse width, the first pulse width and the second pulse width being within a predetermined range;
calculate a preliminary peak location using the histogram data, the preliminary peak location being associated with a target object distance;
compare the preliminary peak location to a threshold value;
calculate a time of flight (TOF) value using the first time and a second time, the second time being based on the corrected peak location or the preliminary peak location; and
determine the target object distance.

2. The system of claim 1, wherein the processor module is further configured to remove the second peak.

3. The system of claim 1, wherein the pixel circuit is characterized by a non-linear response, the first peak being associated with the non-linear response.

4. The system of claim 1, wherein the pixel circuit comprise a SPAD sensor.

5. The system of claim 1, wherein the processor module is further configured to compare the first peak to a first threshold value and a second threshold value, the first threshold value being associated with a high reflection scenario.

6. The system of claim 5, wherein the processor module is further configured to compare the first peak to a second threshold value, the second threshold value being greater than the first threshold value.

7. The system of claim 6, wherein the second threshold value is associated with a glare characteristic attributed to the optical module.

8. The system of claim 5, wherein the processor module is further configured to comparing a third peak and a fourth peak to the second threshold value, the second threshold value being associated with glass reflection.

9. The system of claim 5, wherein the processor module is further configured to comparing a third peak and a fourth peak to the first threshold value, the second threshold value being associated with dust particles.

10. The system of claim 5, wherein the processor module is further configured to identify a third peak and a fourth peak and determine a location difference.

11. A lidar system comprising:
a laser source configured to generate a pulsed laser at a first time, the pulsed laser being characterized by a first pulse width;
an optical module configured receiving a reflected laser signal;
a pixel circuit configured to generate an electrical output based on the reflected laser signal;
a time-to-digital converter (TDC) configured to generate a histogram data using at least the electrical output, the histogram data comprising n intensity values corresponding to n time bins;
a memory device configured to store the histogram data; and
a processor module configured to:
identifying a plurality of peaks;
selecting at least a first peak from the plurality of peaks, the first peak being associated with preliminary peak location;
associating an artifact type to at least a second peak from the plurality of peaks, the second peak being characterized by a low magnitude;
calculate a preliminary peak location using the histogram data, the preliminary peak location being associated with a target object distance;
compare the preliminary peak location to a threshold value;
calculate a time of flight (TOF) value using the first time and a second time, the second time being based on the corrected peak location or the preliminary peak location; and
determine the target object distance.

12. The system of claim 11, wherein the low magnitude is lower than a threshold value.

13. The system of claim 12, wherein the processor module is configured to calculate the threshold value based at least on a characteristic of the first peak.

14. The system of claim 12, wherein the processor module is configured to evaluate a matching function using at least the first peak and the second peak.

15. The system of claim 11, wherein the low magnitude is associated with a glare characteristic attributed to the optical module.

16. A lidar system comprising:
a laser source configured to generate a pulsed laser at a first time, the pulsed laser being characterized by a first pulse width;
an optical module configured receiving a reflected laser signal;
a pixel circuit configured to generate an electrical output based on the reflected laser signal;
a time-to-digital converter (TDC) configured to generate a histogram data using at least the electrical output, the histogram data comprising n intensity values corresponding to n time bins;
a memory device configured to store the histogram data; and
a processor module configured to:
identifying a plurality of peaks;
selecting at least a first peak from the plurality of peaks, the first peak being associated with preliminary peak location and characterized by a second pulse width;
associating an artifact type to at least a second peak and a third peak from the plurality of peaks, the second peak being characterized by a variance;
calculate a preliminary peak location using the histogram data, the preliminary peak location being associated with a target object distance;
compare the preliminary peak location to a threshold value;
calculate a time of flight (TOF) value using the first time and a second time, the second time being based on the corrected peak location or the preliminary peak location; and
determine the target object distance.

17. The device of claim 16, wherein the variance is associated with dust particle locations.

18. The device of claim 16, wherein the variance is associated with glass reflections.

19. The device of claim 16, wherein the processor module is configured to evaluate a matching function using at least the first peak and the second peak.

20. The device of claim 16, wherein the processor module is configured to evaluate a matching function using at least the second pulse width.
